(19) United States
(12) Patent Application Publication
(10) Pub. No.: US 2017/0274943 A1
(43) Pub. Date: Sep. 28, 2017

(54) REAR STRUCTURE OF VEHICLE

(71) Applicant: MAZDA MOTOR CORPORATION, Hiroshima (JP)

(72) Inventors: Yusuke NAKAMURA, Hiroshima-shi (JP); Norihito IWAO, Hiroshima-shi (JP)

(73) Assignee: MAZDA MOTOR CORPORATION, Hiroshima (JP)

(21) Appl. No.: 15/514,226

(22) PCT Filed: Oct. 20, 2016
(86) PCT No.: PCT/JP2016/081093

§ 371 Date: Mar. 24, 2017

(30) Foreign Application Priority Data
Oct. 26, 2015 (JP) 2015-209763

(51) Int. Cl. B62D 35/00; B60Q 1/30; B60Q 1/44; B60Q 1/26

(52) U.S. Cl. CPC B62D 35/007; B60Q 1/2696; B60Q 1/30; B60Q 1/44; B60Y 2400/405; B60Y 2400/412; B60Y 2400/411

(57) ABSTRACT

A rear structure of a vehicle includes: a recess (4) that is provided at rear (1R) of the vehicle and recessed in a front direction of the vehicle; and a partition member (3) that partitions the recess in a vertical direction of the vehicle. The partition member (3) is provided to be movable to a rear side, an upper side, or a lower side of the recess (4) so as to separate from the recess (4).

### TECHNICAL FIELD

The present invention relates to a rear structure of a vehicle.

### BACKGROUND ART

In order to change the direction of traveling wind flowing on the upper surface of a vehicle body to improve aerodynamic performance, there is a case that a rear spoiler is provided at the rear of a vehicle. Generally, such a rear spoiler is provided so as to protrude from the relatively substantially flat surface of a vehicle body.

For example, in the case of a hatchback vehicle, a rear spoiler is often provided so as to protrude rearward from the upper side of the rear surface of a back door extending in a vertical direction. Further, in the case of a notchback vehicle or a fastback vehicle, a known rear spoiler is, as exemplified in Patent Literature 1, one provided so as to protrude upward from the rear side of the upper surface of a trunk lid or a back door extending in a substantially front and rear direction.

However, in terms of a fine view and the layouts of in-vehicle accessories, there is a case that a spoiler is arranged near a recess provided on the side of a vehicle body. In this case, for example, turbulence resulting from the recess may cause an aerodynamically undesirable state. Accordingly, it is desired that this point be improved. Note that the above Patent Literature 1 does not seem to disclose the existence of a recess around a rear spoiler and does not pay any attention to such a problem.

### CITATION LIST

### Patent Literature

Patent Literature 1: U.S. Patent Application Publication No. 2015/0016131

### SUMMARY OF INVENTION

The present invention has an object of reducing the occurrence of turbulence to achieve both the securement of aerodynamic performance and an improvement in a fine view in a configuration in which a spoiler is arranged near a recess provided on the side of a vehicle.

Further, the present invention includes: a recess that is provided at rear of a vehicle and recessed in at least a front direction of the vehicle; and a partition member that partitions the recess in at least a vertical direction of the vehicle, wherein the partition member is provided to be movable to a rear side, an upper side, or a lower side of the recess so as to separate from the recess.

### BRIEF DESCRIPTION OF DRAWINGS

FIG. 1 is a perspective view where the rear of a vehicle according to an embodiment is seen from a rear side.

FIG. 2 is a substantial-part rear view of the rear of the vehicle when a spoiler takes a descending posture.

FIG. 3 is a substantial-part rear view of the rear of the vehicle when the spoiler takes an ascending posture.

FIG. 4 is a perspective view where the left end of the rear side of the vehicle is seen from an upper side when the spoiler takes the descending posture.

FIG. 5 is a substantial-part plan view of the rear of the vehicle when the spoiler takes the ascending posture.

FIG. 6 is a substantial-part left side view of the rear of the vehicle when the spoiler takes the descending posture.

FIG. 7 is a substantial-part left side view of the rear of the vehicle when the spoiler takes the ascending posture.

FIG. 8 is a cross-sectional schematic view of the rear of the vehicle showing the inner structure of a rear lamp unit.

FIG. 9 is a view showing the driving support mechanism of the spoiler (when the spoiler takes the descending posture).

FIG. 10 is a schematic view showing the driving support mechanism of the spoiler (when the spoiler takes the ascending posture).

### DESCRIPTION OF EMBODIMENTS

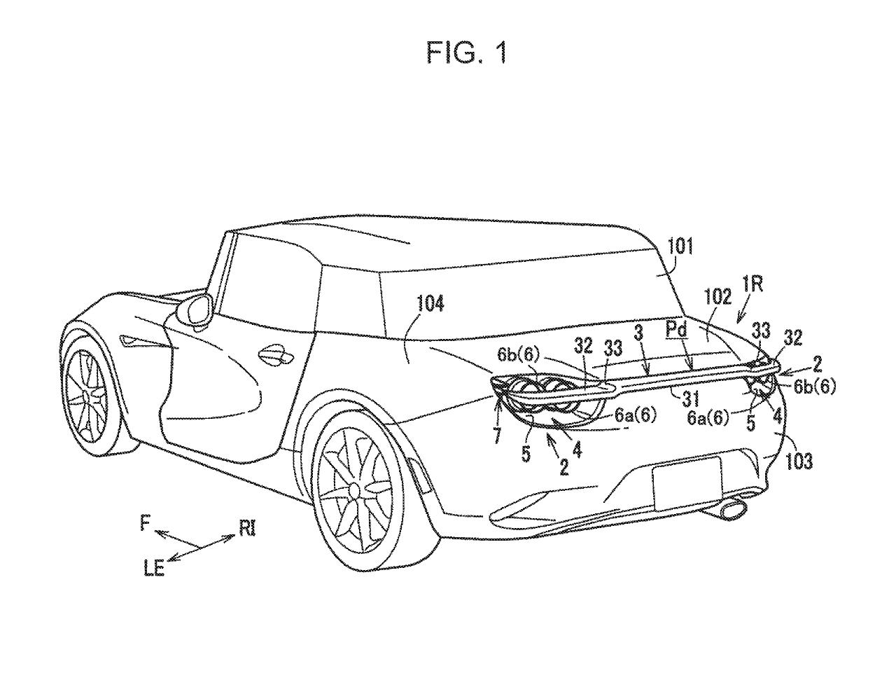

An embodiment of the invention will be described based on FIG. 1 to FIG. 8 below. In the figures, an arrow F denotes the front side of a vehicle, an arrow LE denotes a left side in a vehicle width direction, and an arrow RI denotes a right side in the vehicle width direction.

As shown in FIG. 1 to FIG. 6, rear lamp units 2 are installed on the respective right and left sides of rear 1R of the vehicle, and a rear spoiler 3 (corresponding to the partition member of the present invention) extending in the vehicle width direction is provided on the rear side of a pair of the right and left rear lamp units 2.

Note that in FIG. 1, symbol 101 denotes a back-window glass, symbol 102 denotes a rear deck panel, symbol 103 denotes a bumper face, and symbol 104 denotes a rear fender panel.

At the places of the rear 1R of the vehicle at which the rear lamp units 2 are provided (at the respective right and left places of the rear 1R of the vehicle), recesses 4 where a vehicle body is recessed toward the front side of the vehicle are provided. The recesses 4 extend inward in the vehicle width direction from an outer end in the vehicle width direction when seen in a rear view, and are formed into a horizontally-oriented shape of which the length in the vehicle width direction is greater in size than the length in a vertical direction.

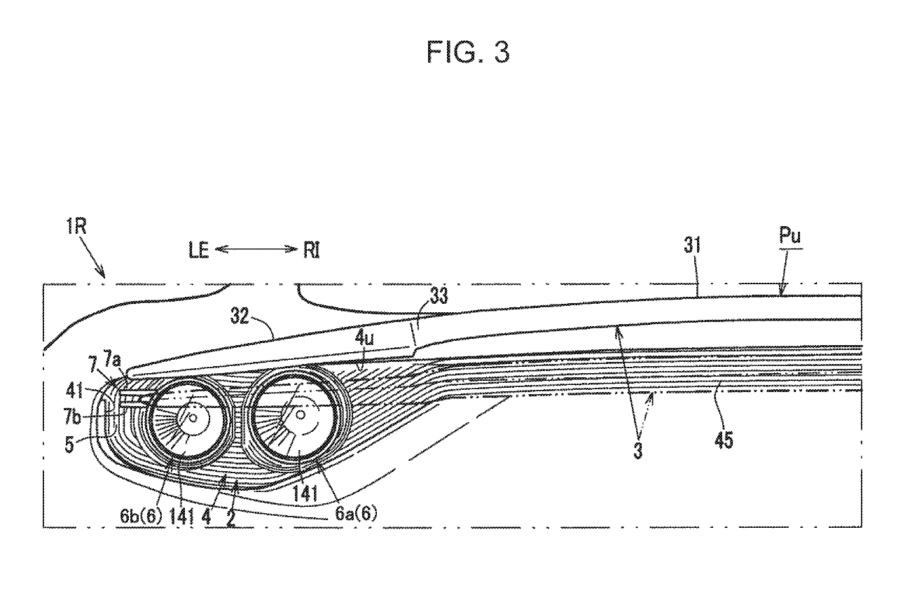

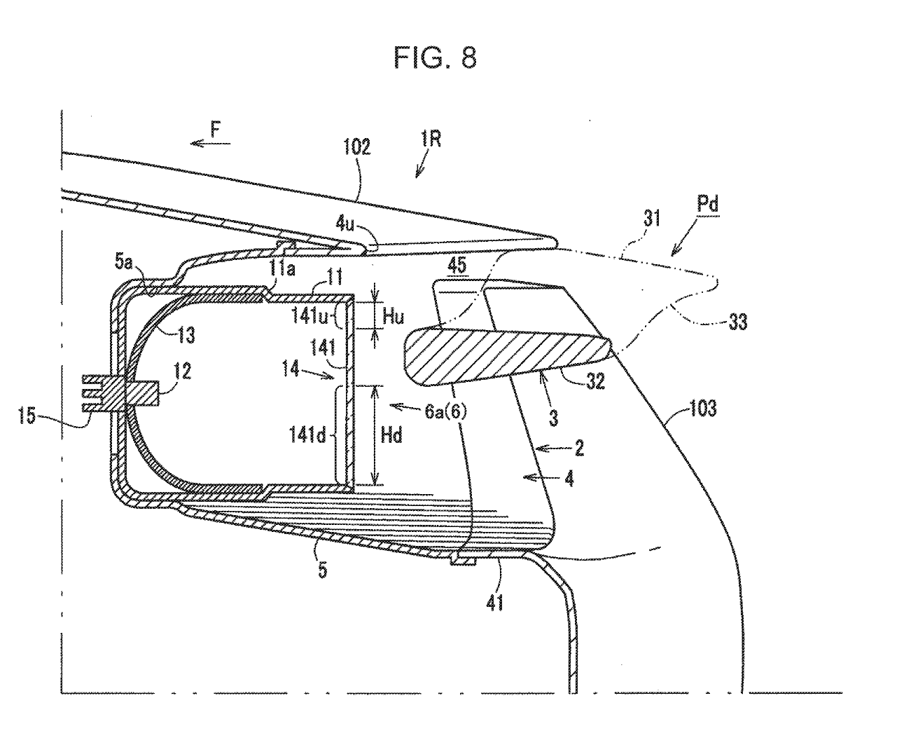

Note that at the rear 1R of the vehicle, a recessed part 45 having a length in the vertical direction shorter in size than those of the recesses 4 are provided so as to continuously connect the right and left rear lamp units 2, i.e., the upper parts of inner ends in the vehicle width direction of the right and left recesses 4 to each other. Thus, the rear 1R of the vehicle is designed so that the right and left rear lamp units 2 are connected to each other in the vehicle width direction via the recessed part 45 (see FIG. 3 and FIG. 8).

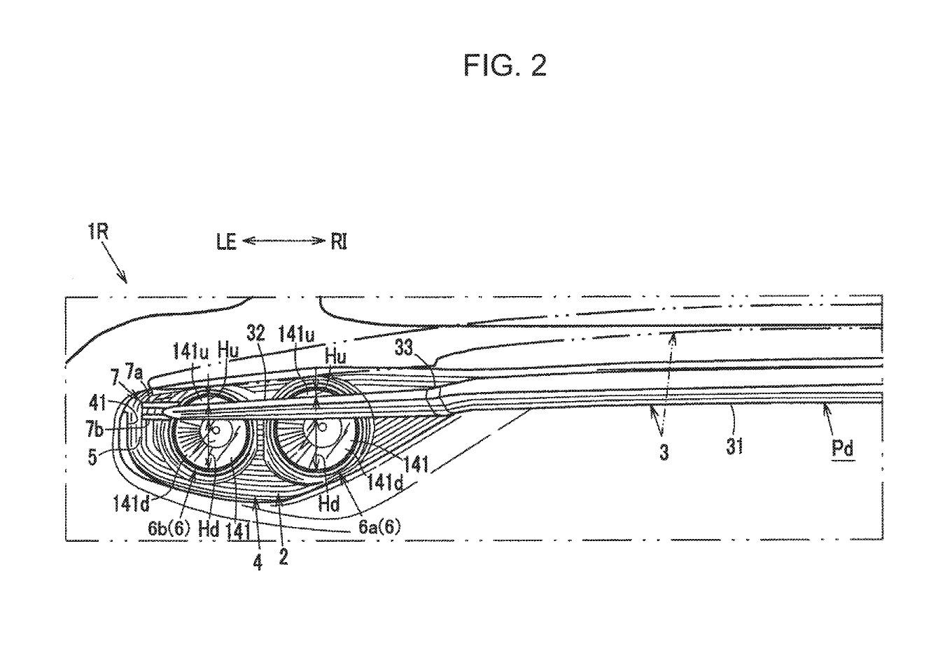

As shown in FIG. 2 to FIG. 7, the vehicle body corresponding to the places of both the right and left ends at the rear 1R of the vehicle at which the rear lamp units 2 are provided has extending edges 41 extending toward the front side, the extending edges 41 serving as the edges of the openings of the recesses 4.

As shown in FIG. 1 to FIG. 8, the inner circumferential surfaces of the recesses 4 described above are substantially entirely made of resin bezels 5 provided in the rear lamp units 2. The bezels 5 are formed into a bottomed shape including an opening at its rear end. As shown in FIG. 8, the front edges of the bezels 5 are brought into contact with the extending edges 41 of the vehicle body. That is, the bezels 5 and the extending edges 41 form the smooth inner circumferential surfaces of the bottomed recesses 4 recessed toward the front side of the vehicle.

Note that the openings of the recesses 4 of the embodiment are not covered with lenses, transparent covers, or the like, and thus spaces inside the recesses 4 are in communication with a space outside the vehicle.

As shown in FIG. 1 to FIG. 7, the rear lamp units 2 include two rear lamp light bodies 6 (6a and 6b) and a turn signal unit 7, the rear lamp light bodies 6 serving as lamp lights arranged side by side from the inside to the outside in the vehicle width direction of the recesses 4 so as to be stored in the recesses 4.

In the embodiment, the rear lamp light bodies 6 (inside rear lamp light bodies 6a) on the inside in the vehicle width direction are backlights (backup signal lights) that light when the vehicle retracts. The rear lamp light bodies 6 (outside rear lamp light bodies 6b) on the outside in the vehicle width direction are tail-and-stop lamps (tail lamps/stop signal lamps) that light when a switch, which is not shown in the figures, inside the vehicle is operated and that further powerfully light when a brake pedal (not shown in the figures) is pressed. The inside rear lamp light bodies 6a and the outside rear lamp light bodies 6b are provided in parallel with each other when seen in a plan view so that their lens surfaces 141 to be described later are oriented to the rear side of the vehicle.

Note that symbols 7a and 7b in FIG. 2 to FIG. 4 denote fin-shaped light guiding plates provided as parts of the turn signal units 7 that guide light from turn-signal light sources, which are not shown in the figures, provided inside the rear lamp units 2 to blink when a turn signal lever is operated. The fin-shaped light guiding plates 7a and 7b are made of translucent members such as acrylic resins.

Next, the inner structure of the rear lamp light bodies 6 will be described. The right and left rear lamp units 2 are formed to be symmetrical, and the inside rear lamp light bodies 6a and the outside rear lamp light bodies 6b described above have substantially the same inner structure. Therefore, the inner structure of the rear lamp light bodies 6 will be described based on FIG. 8 schematically showing the vertical cross section of the inside rear lamp light body 6a of the left rear lamp unit 2. Note that FIG. 8 is an orthogonal cross-sectional view in the vehicle width direction obtained when the central part of the inside rear lamp light body 6a is cut off. Further, FIG. 8 shows a state in which the rear spoiler 3 takes a descending posture, and does not show inner structures at the rear of the vehicle other than the rear lamp unit.

The rear lamp light body 6 (6a) mainly includes a lighting case 11, a LED light source 12, a reflector 13, a lens 14, and a heat sink 15.

The lighting case 11 stores the reflector 13 and the LED light source 12, and is formed into a stepped cylindrical shape including a step 11a so as to make its rear have a diameter smaller in size than that of its front. In the embodiment, the lighting case 11 is attached to a recess 5a (see FIG. 8) formed at the bottom surface of the bezel 5 so that its central axis coincides with a front and rear direction.

The LED light source 12 is provided at the front end and the substantially central part when seen in a rear view of the rear lamp light body 6, and connected to a controller provided outside the rear lamp light body 6 (6a) via a harness or the like although not shown in the figures.

The reflector 13 is provided on the periphery of the LED light source 12, and formed into a substantially U-shape when seen in a side view so as to surround the edge of the LED light source 12 to reflect light emitted from the LED light source 12 toward the rear side of the vehicle.

The lens 14 is formed into a flat shape when seen in a cross-sectional view by a transparent synthetic resin, and attached so as to close an opening at the rear end of the lighting case 11.

The heat sink 15 is provided outside the rear lamp light body 6 and in front of the LED light source 12 so as to correspond to the LED light source 12, and has a function as a radiation unit that radiates heat emitted from the LED light source 12 to a surrounding area.

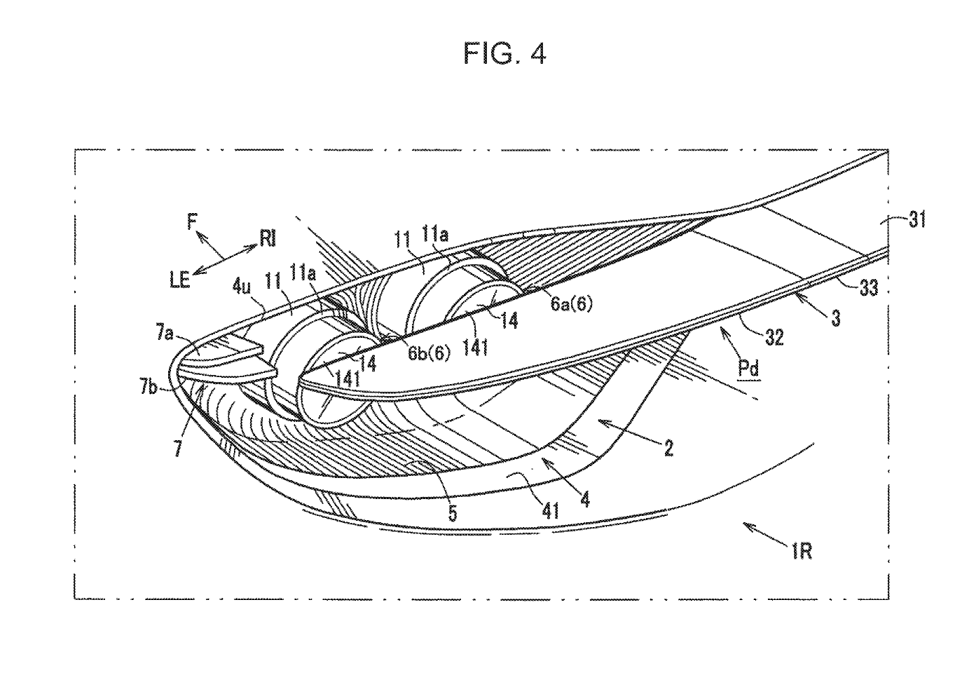

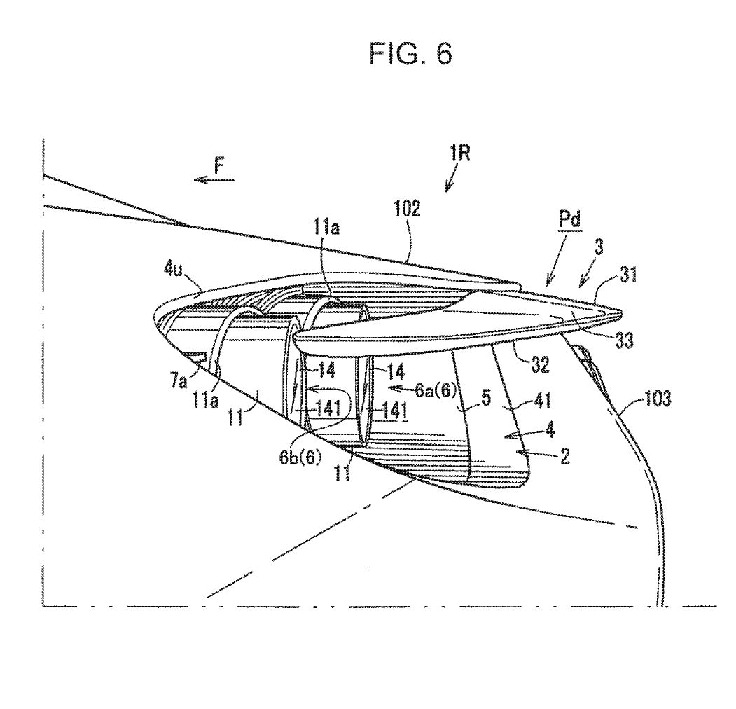

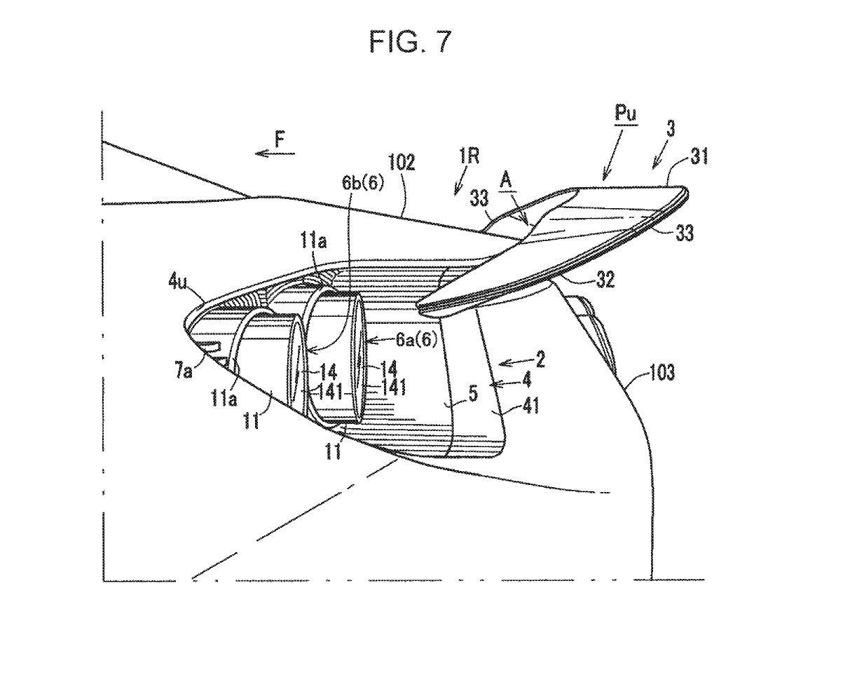

As shown in FIG. 1, the rear spoiler 3 is a resin-made plate-shaped member extending over a substantially entire length in the vehicle width direction at the rear 1R of the vehicle. As shown in FIG. 1 to FIG. 7, the rear spoiler 3 integrally has a central part 31 positioned on a central side in the vehicle width direction, outer parts 32 positioned on both outer sides in the vehicle width direction than the central part 31 and positioned lower in height than the central part 31, and a coupling part 33 coupling these parts to each other, and is formed to be symmetrical. The rear spoiler 3 is formed into a plate shape elongated in the vehicle width direction as a whole, in which each of the central part 31, the coupling parts 33, and the outer parts 32 has a length in the front and rear direction greater in size than a thickness in a vertical direction. Such a rear spoiler 3 is configured to move between a descending posture Pd in which the rear spoiler 3 descends to a position at which the rear lamp light bodies 6 are partitioned in the vertical direction of the vehicle as shown in FIG. 2, FIG. 4, and FIG. 6 and an ascending posture Pu in which the rear spoiler 3 ascends from the descending posture Pd as shown in FIG. 3 and FIG. 7.

As shown in FIG. 1, FIG. 2, FIG. 4, and FIG. 6, the outer parts 32 of the rear spoiler 3 extend in the vehicle width direction so as to reach outer ends in the vehicle width direction of the rear lamp units 2 across the rear lamp units 2 in a state in which the rear spoiler 3 takes the descending posture Pd.

Specifically, the outer parts 32 of the rear spoiler 3 extend so as to vertically partition (traverse) the lens surfaces 141 provided at the rear ends of the rear lamp light bodies 6 (the inside rear lamp light bodies 6a and the outside rear lamp light bodies 6b) when seen in a rear view (see FIG. 1, FIG. 2, FIG. 4, and FIG. 6). Thus, the outer parts 32 of the rear spoiler 3 are arranged so that the lens surfaces 141 of the rear lamp light bodies 6, i.e., the blinking of the rear lamp light bodies 6 can be directly visually confirmed from both the upper and lower sides of the outer parts 32 (see FIG. 2 and FIG. 4).

More specifically, the outer parts 32 of the rear spoiler 3 are arranged so that lower parts 141d of the lens surfaces 141 on the lower side of the outer parts 32 have a length in the vertical direction greater in size than upper parts 141u thereof on the upper side of the outer parts 32 (Hd>Hu) when seen in a rear view (see FIG. 2 and FIG. 8).

That is, as shown in FIG. 8, the outer parts 32 are arranged so as to vertically partition the lens surfaces 141 of the rear lamp light bodies 6 on the upper side of intermediate parts in the vertical direction of the lens surfaces 141 when seen in a rear view.

In addition, in a state in which the rear spoiler 3 is arranged to take the descending posture Pd, the outer parts 32 are arranged so as to face the lens surfaces 141 from the rear side in a state of getting in the inside of the openings of the recesses 4 when seen in a plan view (see FIG. 6 and FIG. 8).

The outer parts 32 extend in the front and rear direction (i.e., the outer parts 32 have a length in the front and rear direction), but the lower parts 141d of the lens surfaces 141 of the rear lamp light bodies 6 on the lower side of the outer part 32 are arranged so as to be capable of being directly visually recognized when seen in a rear view (see FIG. 2).

Here, in a case different from the case of the embodiment in which the lens surfaces 141 are arranged so as to be oriented to the rear side of the vehicle, for example, in the case of a configuration (not shown in the figures) in which the lens 14 is arranged with an elevation angle so that the lens surfaces 141 are oriented to an obliquely upper side in a rear direction, the lower parts 141d of the lens surfaces 141 overlap with the outer parts 32 when seen in a plan view and may not be visually recognized from, for example, the obliquely upper side in the rear direction. However, since the lower parts 141d have a length in the vertical direction greater in size than the upper parts 141u with respect to the outer parts 32, the remaining lower parts 141d other than the above overlapped parts can be directly visually recognized from the obliquely upper side in the rear direction or an upward direction.

As shown in FIG. 1, FIG. 2 and FIG. 3, the central part 31 of the rear spoiler 3 is positioned at a place corresponding to a substantially intermediate part between the pair of right and left rear lamp units 2 in the vehicle width direction, and at least the upper surface of the central part 31 extends in the vehicle width direction at a height above the lens surfaces 141 of the rear lamp light bodies 6 not only in the ascending posture Pu but also in the descending posture Pd (see FIG. 2).

In addition, as shown in FIG. 6, the central part 31 of the rear spoiler 3 is positioned at the upper end of the bumper face 103 forming the rear surface of the rear 1R of the vehicle and arranged so as to protrude to the rear side from the rear end of the rear deck panel 102 in the descending posture Pd.

As shown in FIG. 2 and FIG. 6, each of the upper surfaces of the central part 31 and the outer parts 32 of the rear spoiler 3 described above is formed into a smooth curved surface gradually inclined to the lower side so as to be lower toward the outside in the vehicle width direction and lower toward the rear side of the vehicle.

Further, the coupling parts 33 are formed into a smooth stepped-shape inclined downward toward the outside in the vehicle width direction so as to couple the central part 31 and the outer parts 32 arranged at a position on an outer side in the vehicle width direction lower in height than the central part 31 to each other (see FIG. 1, FIG. 2, and FIG. 6), and inclined so as to be gradually positioned on an inner side in the vehicle width direction toward the rear side (see FIG. 4 to FIG. 6).

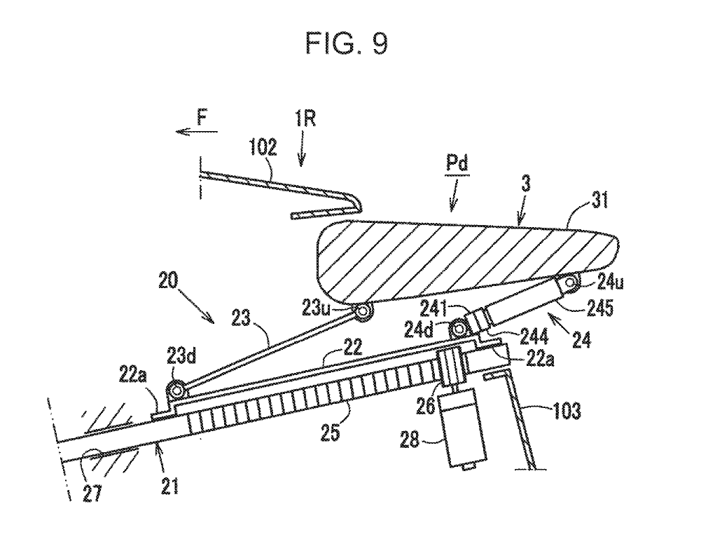

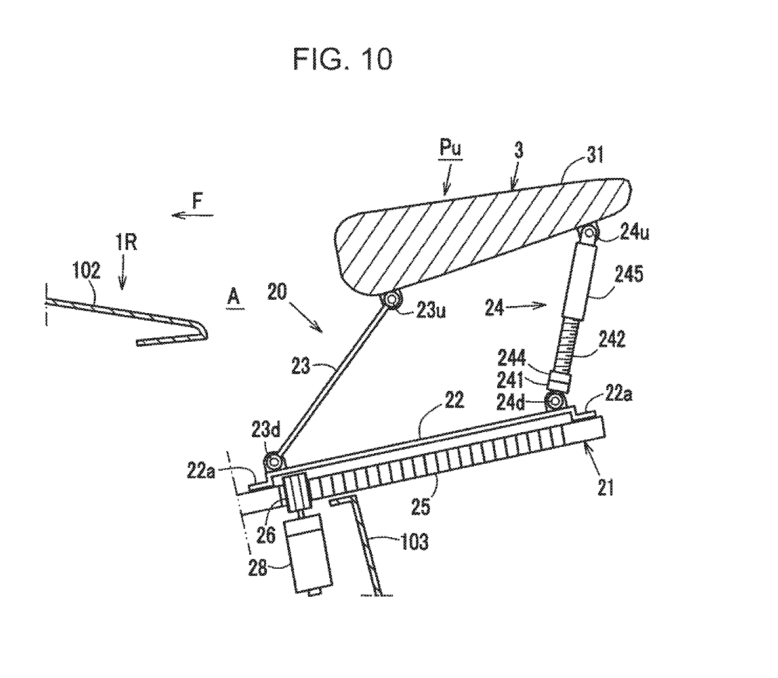

As shown in FIG. 9 and FIG. 10, the rear spoiler 3 described above is supported by a driving support mechanism 20 (corresponding to the driving mechanism of the present invention) so as to be changeable to any of the descending posture Pd and the ascending posture Pu.

The driving support mechanism 20 is substantially entirely incorporated into the central part 31 in the vehicle width direction at the rear 1R of the vehicle, and supports the central part 31 of the rear spoiler 3 from below so that the rear spoiler 3 changes between the descending posture Pd and the ascending posture Pu.

A description will be given of an embodiment of the driving support mechanism 20 with reference to schematic views shown in FIG. 9 and FIG. 10. The driving support mechanism 20 mainly includes a base board 21, an arm attachment bracket 22, a support arm 23, and an expansion/contraction support arm 24.

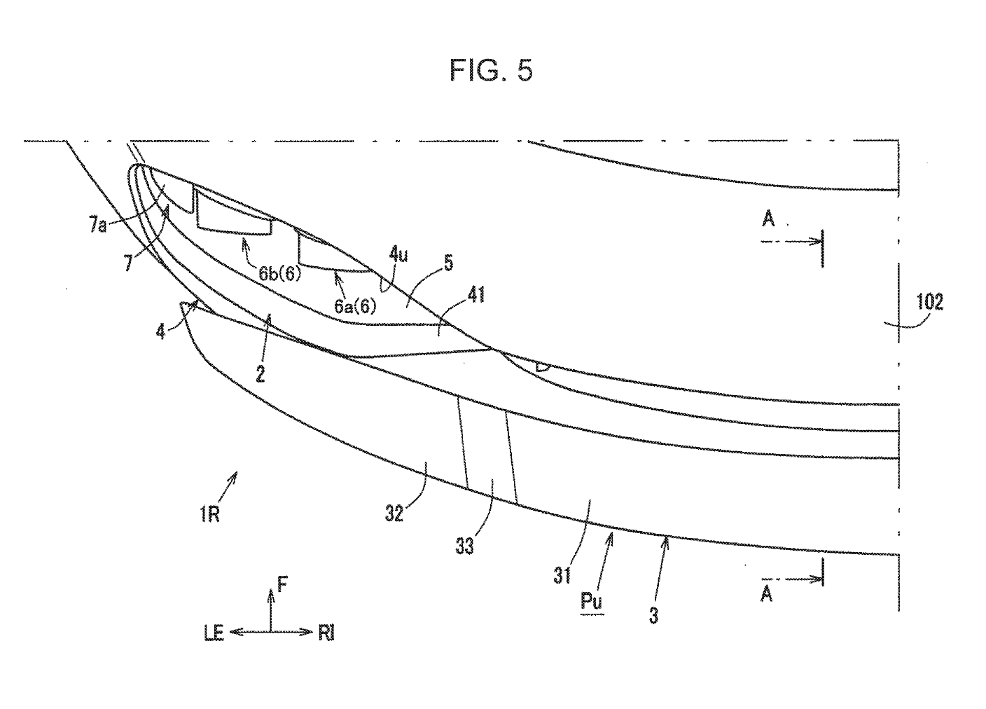

Note that FIG. 9 is a configuration explanation view schematically showing the driving support mechanism in a cross section taken along line A-A in FIG. 5, and FIG. 9 and FIG. 10 are a cross-sectional view where the rear spoiler takes the descending posture and a cross-sectional view where the rear spoiler takes the ascending posture, respectively. However, in the figures, structures inside the vehicle body other than the driving support mechanism are not shown. Further, the support arm 23 and the expansion/contraction support arm 24 are provided in pairs on both right and left sides of a central part in the vehicle width direction at the rear 1R of the vehicle, and thus the rear spoiler 3 is supported by the four support arms 23 and 24 in total. However, in FIG. 9 and FIG. 10, only the support arm 23 and the expansion/contraction support arm 24 on one of both the right and left sides in the vehicle width direction are shown.

The vehicle body is provided with a guide member 27 (see FIG. 9), and the base board 21 made of a plate-shaped member is slidably supported by the guide member 27 (see FIG. 9) so as to protrude or retract to the rear side with respect to the rear 1R of the vehicle.

The base board 21 is provided with a rack 25 along its sliding direction, and the vehicle body is provided with a pinion 26 that meshes with the rack 25 and a base-board sliding motor 28 that rotates and drives the pinion 26. Thus, the base board 21 is driven.

The arm attachment bracket 22 has rigidity with which the support arm 23 and the expansion/contraction support arm 24 can be supported, and is integrally fastened to the upper surface of the base board 21 via a flange 22a formed at its outer end.

The expansion/contraction support arm 24 includes an arm expansion/contraction motor 241, a screw shaft 242 (see FIG. 10), a boss 244 (coupling) that is interposed between the arm expansion/contraction motor 241 and the screw shaft 242 and transmits the driving force of the arm expansion/contraction motor 241 to the screw shaft 242, and a nut member 245 screwed with the rotation of the screw shaft 242.

The support arm 23 is a driven link that rotates in conjunction with the rotation of the expansion/contraction support arm 24 serving as a main driving link.

The support arm 23 and the expansion/contraction support arm 24 are coupled at their upper ends to the respective front and rear of the lower surface of the rear spoiler 3 via pivotally-attached parts 23u and 24u, respectively. That is, the expansion/contraction support arm 24 is coupled to the lower surface of the rear spoiler 3 at the upper end of the nut member 245.

On the other hand, the support arm 23 and the expansion/contraction support arm 24 are coupled at their lower ends to the respective front and rear of the attachment bracket via pivotally-attached parts 23d and 24d, respectively. Thus, the support arm 23 and the expansion/contraction support arm 24 are coupled to the base board 21 via the arm attachment bracket 22.

When the rear spoiler 3 is caused to move from the descending posture Pd shown in FIG. 9 to the ascending posture Pu shown in FIG. 10 by the driving support mechanism 20 described above, the pinion 26 is rotated by the driving of the base-board sliding motor 28 and the base board 21 is moved straight from the rear 1R of the vehicle to an outside rearward by the pinion 26 and the rack 25. Thus, the rear spoiler 3 separates from the recesses 4 to the rear side of the vehicle.

After that, the nut member 245 moves straight when the screw shaft 242 is rotated by the driving of the arm expansion/contraction motor 241, and thus the expansion/contraction support arm 24 expands. By the expansion of the expansion/contraction support arm 24, the support arm 23 and the expansion/contraction support arm 24 rotate counterclockwise when seen in a left view so as to rise with respect to the base board 21 in conjunction with each other and push up the rear spoiler 3 from beneath. Thus, the rear spoiler 3 moves to the ascending posture Pu while moving to the upper side of the vehicle (see FIG. 7).

Here, with attention paid to the outer parts 32 of the rear spoiler 3, the outer parts 32 move so as to separate from the recesses 4 to the rear and upper sides as the rear spoiler 3 moves from the descending posture Pd to the ascending posture Pu.

That is, the outer parts 32, which have been arranged at the height at which the rear lamp light bodies 6 are vertically partitioned in a state in which the rear spoiler 3 takes the descending posture Pd as shown in FIG. 2 and FIG. 6, are arranged at a position at which the outer parts 32 separate from upper edges 4u of the recesses 4 to the upper and rear sides as shown in FIG. 2 and FIG. 7 in a state in which the rear spoiler 3 takes the ascending posture Pu.

In other words, the outer parts 32 are arranged on the upper side of the rear lamp light bodies 6 in the ascending posture Pu. That is, in the embodiment, the outer parts 32 are arranged above the upper end of the lens surfaces 141 of the rear lamp light bodies 6 in the ascending posture Pu (see FIG. 3).

On the other hand, with attention paid to the central part 31 of the rear spoiler 3, the central part 31 is arranged so as to extend from the rear end of the rear deck panel 102 and the upper end of the bumper face 103 to the rear side when seen in a side view in a state in which the rear spoiler 3 takes the descending posture Pd (see FIG. 6), but arranged so as to separate from the rear deck panel 102 to the upper side and from the bumper face 103 to the rear side in a state in which the rear spoiler 3 takes the ascending posture Pu (see FIG. 7 and FIG. 10). That is, a space A communicating in the front and rear direction is formed between the lower surface of the central part 31 of the rear spoiler 3 and the rear deck panel 102. Note that the central part 31 and the outer parts 32 of the rear spoiler 3 are inclined downward toward the front side of the vehicle in a state in which the rear spoiler 3 takes the ascending posture Pu (see FIG. 6).

Note that when the rear spoiler 3 is caused to move from the ascending posture Pu to the descending posture Pd, the operation of moving the rear spoiler 3 from the descending posture Pd to the ascending posture Pu described above is performed in the reverse direction. That is, the expansion/contraction support arm 24 is contracted to move to the lower side, and then the base board 21 is retracted into the inside of the rear 1R of the vehicle.

In the embodiment, the rear spoiler 3 is kept in the descending posture Pd when the vehicle is stopped, and caused to move to the ascending posture Pu when the driving support mechanism 20 described above is automatically driven as the vehicle travels. Note that the traveling and stop of the vehicle can be detected, for example, based on whether an accelerator pedal has been pressed, but the specific configuration of the detection means is not particularly limited.

In the rear structure of the vehicle of the embodiment, the recesses 4 formed to be recessed in at least the front direction of the vehicle are provided at the rear 1R of the vehicle (see FIG. 1 to FIG. 8), the rear spoiler 3 serving as the partition member that partitions the recesses 4 in at least the vertical direction of the vehicle is provided (see FIG. 1 to FIG. 4, FIG. 6, and FIG. 8), and the rear spoiler 3 is provided to be movable to the rear side, the upper side, or the lower side of the recesses 4 so as to separate from the recesses 4 (see FIG. 3 and FIG. 7).

According to the above configuration, entangling wind (turbulence) occurs in each of the upper and lower areas of the recesses 4 at the time of traveling or the like when the rear spoiler 3 is arranged so as to partition the recesses 4 provided at the rear 1R of the vehicle in the vertical direction of the vehicle, but the occurrence of the turbulence can be reduced by causing the rear spoiler 3 to separate from the recesses 4 where necessary.

More specifically, in the recesses 4 provided at the rear 1R of the vehicle, negative pressure is generated when there is a difference in the speed between traveling wind flowing in the recesses 4 and traveling wind flowing outside the recesses 4. Therefore, traveling wind flowing to the rear side on the vehicle body (the rear fender panel 104 and the rear deck panel 102) at the rear 1R of the vehicle is attracted to the recesses 4, whereby turbulence (eddy) due to entangling wind may occur. Accordingly, when the rear spoiler 3 is arranged so as to partition the recesses 4 at the rear 1R of the vehicle in the vertical direction of the vehicle, the effect of reducing turbulence (rectifying effect) by the rear spoiler 3 does not become great.

However, the aerodynamic performance of the rear spoiler 3 can be adjusted by causing the rear spoiler 3 to separate from the recesses 4. Specifically, when the rear spoiler 3 is caused to move to the upper side in the rear direction with respect to the recesses 4, the space A is secured between the upper ends of the recesses 4 at the rear 1R of the vehicle and the lower surface of the rear spoiler 3 (see FIG. 7 and FIG. 10), whereby traveling wind flowing to the rear side is taken in the recesses 4 via the space A. Therefore, the generation of negative pressure inside the recesses 4 and thus the occurrence of turbulence can be reduced.

That is, according to the above configuration, the fine view or the like of the vehicle can be secured when the rear spoiler 3 is arranged at the position of the descending posture Pd, i.e., the position at which the rear spoiler 3 partitions the recesses 4 at the rear 1R of the vehicle in the vertical direction of the vehicle. On the other hand, when the rear spoiler 3 is arranged at the position of the above ascending posture Pu at the time of traveling (particularly at the time of traveling along a highway), aerodynamic performance can be secured with a reduction in the occurrence of turbulence. Accordingly, by the configuration in which the rear spoiler 3 is arranged near the recesses 4 provided at the rear 1R of the vehicle, both the securement of the aerodynamic performance and an improvement in the fine view can be achieved.

Further, according to the embodiment of the invention, the driving support mechanism 20 is provided as a mechanism to drive the rear spoiler 3 (see FIG. 9 and FIG. 10), and the driving support mechanism 20 moves the rear spoiler 3 when the vehicle travels (see FIG. 3, FIG. 5, and FIG. 7).

Therefore, the trouble of moving the rear spoiler 3 can be saved, and forgetting to move the rear spoiler 3 can be prevented. As a result, the effect of reducing turbulence with the rear spoiler 3 can be reliably obtained.

Further, according to the embodiment of the invention, the rear spoiler 3 is configured to be movable to the upper and rear sides of the upper edges 4u of the recesses 4 (see FIG. 3 and FIG. 7).

According to the above configuration, traveling wind can be introduced between the upper edges 4u of the recesses 4 and the lower place of the rear spoiler 3 by causing the rear spoiler 3 to separate toward the upper and rear sides of the upper edges 4u of the recesses 4 when the vehicle travels. Therefore, the occurrence of rearward turbulence from the recesses 4 can be reduced.

Further, according to the embodiment of the invention, the rear spoiler 3 is configured to be movable to the upper side of the vehicle after moving to the rear side of the vehicle (see FIG. 9 and FIG. 10).

According to the above configuration, the driving support mechanism 20 is configured to move the rear spoiler to the upper side of the vehicle after moving the same to the rear side of the vehicle. Therefore, the driving support mechanism 20 can be formed to be compact. In addition, the rear spoiler 3 can be caused to move to the rear and upper sides of the recesses 4 without interfering with the rear 1R of the vehicle with minimum movement.

The invention is not limited to only the configurations of the embodiment described above.

For example, the recesses of the present invention are not limited to those each of which is provided at the rear 1R of the vehicle to store the two rear lamp light bodies 6 and the turn signal unit 7 provided in the rear lamp unit 2 like the embodiment described above, but may be those provided at other places at the rear 1R of the vehicle in terms of a fine view and the layout of in-vehicle accessories. Further, the rear spoiler 3 (partition member) is not limited to one that moves to the upper and rear sides of the vehicle like the embodiment described above, but may be configured to move to, for example, the lower side of vehicle from the recesses 4. In addition, the rear spoiler 3 (partition member) of the present invention is not limited to one that partitions the recesses 4 over the entire vehicle width direction like the embodiment described above, but may be configured to partially partition the recesses 4 in the vehicle width direction. By any of the configurations described above, the occurrence of turbulence can be reduced.

The present invention described above is summarized as follows.

That is, a rear structure of a vehicle according to the present invention includes: a recess that is provided at rear of the vehicle and recessed in at least a front direction of the vehicle; and a partition member that partitions the recess in at least a vertical direction of the vehicle, wherein the partition member is provided to be movable to a rear side, an upper side, or a lower side of the recess so as to separate from the recess.

According to the above configuration, the fine view or the like of the vehicle can be secured by providing the partition member so as to partition the recess provided at the rear of the vehicle in the vertical direction of the vehicle. In this case, wind (turbulence) entangled in the recess occurs in each of the upper and lower areas of the recess at the time of traveling or the like. However, the occurrence of the turbulence can be reduced by causing the partition member to separate from the recess where necessary. Accordingly, both the securement of the aerodynamic performance and an improvement in the fine view can be achieved.

Note that the expression “to a rear side, an upper side, or a lower side of the recess” described above includes directions in which the rear side, the upper side, and the lower side are combined together, i.e., the upper side in a rear direction and the lower side in the rear direction.

In the above configuration, the rear structure of the vehicle preferably includes: a driving mechanism that drives the partition member, wherein the driving mechanism moves the partition member when the vehicle travels.

According to the above configuration, the occurrence of turbulence can be reduced by causing the partition member to separate from the recess when the vehicle travels.

Further, in the above configuration, the partition member is preferably configured to be movable further toward upper and rear sides than an upper edge of the recess.

According to the above configuration, the occurrence of rearward turbulence can be reduced by introducing traveling wind between the upper edge of the recess and the lower place of the partition member.

Further, in the above configuration, the partition member is preferably configured to be movable to an upper side of the vehicle after moving to a rear side of the vehicle with respect to the recess.

According to the above configuration, a driving member can be formed to be compact.

### INDUSTRIAL APPLICABILITY

As described above, the present invention is useful for the rear structure of a vehicle provided with a recess recessed in at least the front direction of the vehicle.

1. A rear structure of a vehicle comprising:
a recess that is provided at rear of the vehicle and recessed in at least a front direction of the vehicle; and
a partition member that partitions the recess in at least a vertical direction of the vehicle, wherein
the partition member is provided to be movable to a rear side, an upper side, or a lower side of the recess so as to separate from the recess.

2. The rear structure of the vehicle according to claim 1, comprising:
a driving mechanism that drives the partition member, wherein
the driving mechanism moves the partition member when the vehicle travels.

3. The rear structure of the vehicle according to claim 1, wherein
the partition member is configured to be movable further toward upper and lower sides than an upper edge of the recess.

4. The rear structure of the vehicle according to claim 1, wherein
the partition member is configured to be movable to an upper side of the vehicle after moving to a rear side of the vehicle with respect to the recess.

5. The rear structure of the vehicle according to claim 2, wherein
the partition member is configured to be movable further toward upper and lower sides than an upper edge of the recess.

6. The rear structure of the vehicle according to claim 2, wherein
the partition member is configured to be movable to an upper side of the vehicle after moving to a rear side of the vehicle with respect to the recess.

7. The rear structure of the vehicle according to claim 3, wherein
the partition member is configured to be movable to an upper side of the vehicle after moving to a rear side of the vehicle with respect to the recess.

8. The rear structure of the vehicle according to claim 5, wherein
the partition member is configured to be movable to an upper side of the vehicle after moving to a rear side of the vehicle with respect to the recess.
